(19) United States
(12) Patent Application Publication
(10) Pub. No.: US 2008/0054104 A1
(43) Pub. Date: Mar. 6, 2008

(54) COMPRESSED AIR GUNS, HANDPIECES, AND NOZZLES

(75) Inventors: Thomas C. Tremblay, Concord, MA (US); Mark W. Yorns, Longmeadow, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: Guardair Corporation, Chicopee, MA (US)

(21) Appl. No.: 11/468,551

(22) Filed: Aug. 30, 2006

(51) Int. Cl. B05B 1/30

(52) U.S. Cl. 239/586; 239/583; 239/525

(57) ABSTRACT

An airgun may include a body and a nozzle. The body may include a shaft defining a main bore, a compressed air inlet in fluid communication with a first end of the main bore, an extension in fluid communication with a second end of the main bore, a valve being biased to a closed position and regulating flow through the main bore, and/or a valve-operating lever attached to the body and operably coupled to the valve. The extension and the shaft may lie along a common axis. The lever may include a hand engagement blade. The lever may rest in a first position in which the hand engagement blade runs oblique to a common axis of the shaft and the extension and in which the valve adopts the closed position. The lever may be transitionable to a second position in which the hand engagement blade runs parallel or substantially parallel to the common axis of the shaft and the extension and in which the valve adopts an open position. The nozzle may be attached to and in fluid communication with the extension.

### BACKGROUND

Compressed air guns (“airguns”) are used to deliver a stream of pressurized air through a nozzle to a target. Exemplary uses include clearing debris, removing dust, and other cleaning tasks. Airguns typically include a handle and a nozzle connected to the handle. The handle receives a pressurized air supply and directs it to the nozzle under the control of a user-operated valve.

### SUMMARY

This application describes device, device components, and methods for delivering streams of pressurized fluid, such as air, water, oil, and/or mixtures of fluids.

In one embodiment, an airgun may include a body and a nozzle. The body may include a shaft defining a main bore, a compressed air inlet in fluid communication with a first end of the main bore, an extension in fluid communication with a second end of the main bore, a valve being biased to a closed position and so intersecting the main bore as to regulate flow through the main bore, and/or a valve-operating lever attached to the body and operably coupled to the valve. The extension and the shaft may lie along a common axis. The lever may include a hand engagement blade having a free end. The lever may rest in a first position in which the hand engagement blade runs oblique to a common axis of the shaft and the extension and in which the valve adopts the closed position and blocks flow through the main bore. The lever may be transitionable to a second position in which the hand engagement blade runs parallel or substantially parallel to the common axis of the shaft and the extension and in which the valve adopts an open position and permits flow through the main bore. The nozzle may be attached to and in fluid communication with the extension.

In one embodiment, a nozzle for an airgun may include a nozzle shaft defining a main nozzle bore and having a wall through which at least one side hole is defined. The shaft may include a first end defining an inlet and, optionally, a beveled second end defining an outlet. The at least one side hole may form a venturi with the main nozzle bore.

A method of operating an airgun may include directing the nozzle at a site to which pressurized air is to be directed, grasping the shaft and the hand engagement blade in a hand, and squeezing the hand engagement blade toward the shaft, thereby opening the valve.

### BRIEF DESCRIPTION OF THE DRAWINGS

FIG. 1 depicts a perspective view of an exemplary airgun.

FIG. 2 depicts a perspective view of an exemplary airgun body.

FIG. 3 depicts a longitudinal cross-sectional view of an exemplary airgun body.

FIG. 4 depicts a side elevation view of an exemplary airgun body having a lever in a first position.

FIG. 5 depicts a side elevation view of an exemplary airgun body having a lever in a second position.

FIG. 6 depicts a side elevation view of an exemplary airgun body having a lever in a third position between the first and second positions.

FIG. 7 depicts a side elevation view of an exemplary airgun nozzle with a beveled tip.

FIG. 8 depicts a longitudinal cross-sectional view of an exemplary airgun nozzle with a beveled tip.

FIG. 9 depicts a longitudinal cross-sectional view of an exemplary airgun nozzle with a blunt tip.

FIGS. 10 and 11 depict exemplary modes of operation of an exemplary airgun.

### DETAILED DESCRIPTION

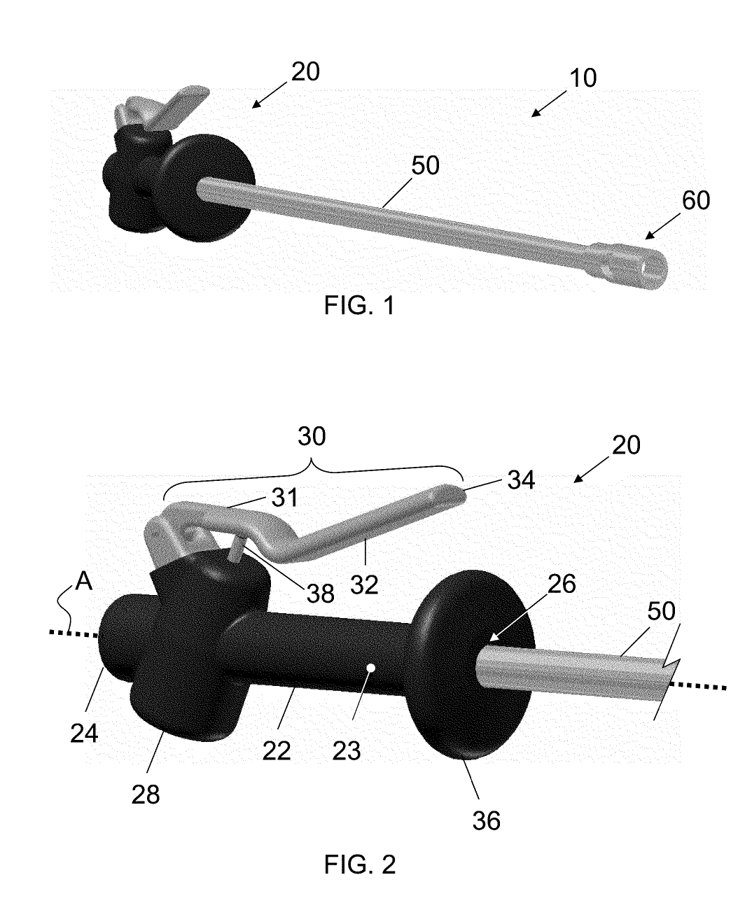

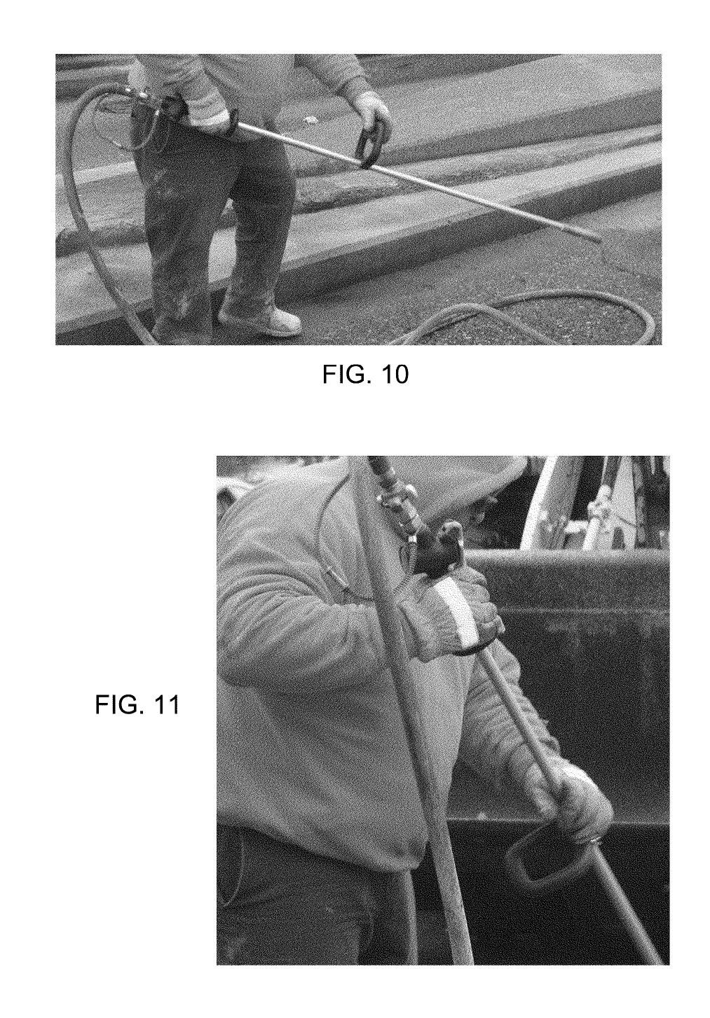

FIG. 1 depicts an exemplary embodiment of an airgun 10, which includes a body 20, an extension 50, and a nozzle 60 connected to the extension. The airgun may optionally include an auxiliary handle (shown in FIGS. 10 and 11) attached to the extension 50 that extends from the body to the nozzle.

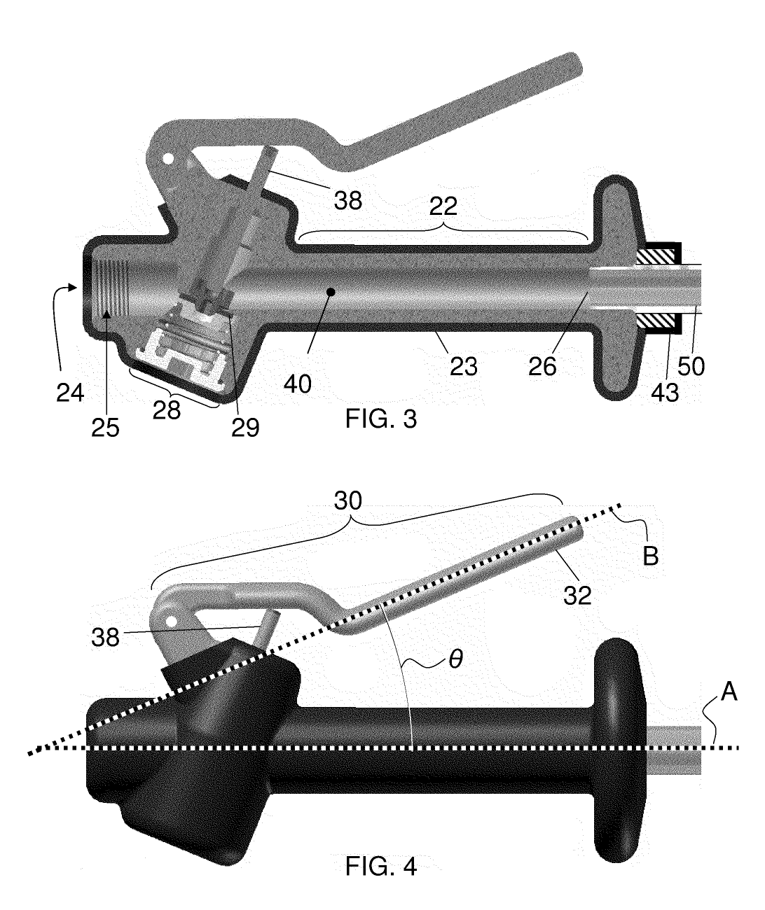

FIG. 2 depicts the airgun body in greater detail, and FIG. 3 depicts a cross-sectional view of the body. The body includes a shaft 22 which may, along with other parts, be covered in whole or in part with rubber, thermoset elastomer, thermoplastic elastomer, polyurethane, or other material 23 that improves comfort, provides to the body a surface that may be gripped by a user more easily than bare metal, and/or provide thermal insulation to protect the user. The shaft defines a main bore 40 that runs through the center of the shaft. The main bore fluidly communicates with a pressurized air inlet 24 (which may have threads 25 to receive securely a line having complementary threads) and a body outlet 26. A valve assembly 28 so intersects the main bore as to regulate flow through the main bore by opening and closing. In the exemplary embodiment illustrated, the value assembly includes a stem 38, the depression of which opens the seal 29.

The shaft (with its main bore) is straight and lies along an axis A. The outlet also lies along this axis and so is coaxial, or collinear, with the main bore and shaft. The inlet may also, but need not, be collinear with the main shaft and the outlet.

A lever 30 is connected to the body or to a part of the body (in the illustrated embodiment, it is hinged to the body) and so positioned that movement of the lever operates the seal. The valve assembly may be biased to a closed position (stem out), so that the valve assembly does not open unless the lever presses it in such a way as to open it (e.g., by depressing the stem). The lever may include a valve assembly-contacting portion 31, a hand engagement blade 32 and/or a free end 34. The hand engagement blade may be so sized and/or shaped as to permit comfortable grasping by a human hand. It may have a length sufficiently longer than the length from the pivot to the point of valve contact in the valve assembly-contacting portion to provide a mechanical advantage. Such a mechanical advantage reduces the amount of grasping force a user must exert to maintain the lever in a valve-opening position. The hand engagement blade may be coated in whole or in part with material 23 (not shown).

In a resting state, the lever adopts a first position in which its hand engagement blade is oriented obliquely to axis A. It is typically held in that position by some portion of the valve which is biased to a valve-closed position. When the hand engagement blade is pressed toward the shaft, the lever presses against the valve part (stem 38 in the illustrated embodiment) and causes it to transition to a valve-open position. The force exerted by the lever on the valve contact part must exceed the bias that tends to hold the valve in the closed position (although the force exerted by the user on the hand engagement blade may be less because it is amplified by the mechanical advantage). If the force falls below that of the bias, then the valve transitions back to its resting, closed state. This arrangement is termed a “dead-man trigger” by some because the device will automatically shut off if the user loses his or her grip on the body or otherwise loses control of the device.

A lever guard (i.e., a structure partially surrounding the lever to prevent accidental motion or damage if the airgun is dropped) may be provided.

The body may include a buttress 36. This buttress may provide a surface against which a user may thrust his or her hand to impart force to the nozzle (when using the nozzle for striking, described below). It may also serve to protect the hand and/or to protect the lever.

The body may include a boss 43 at the outlet and/or where the extension connects to the body. The boss may be coated in whole or in part with material 23.

The extension may have a length ranging from negligible (i.e., about zero inches) up to about 20 feet. Exemplary lengths include about 1 foot, about 2 feet, about 3 feet, about 4 feet, about 5 feet, and about 6 feet.

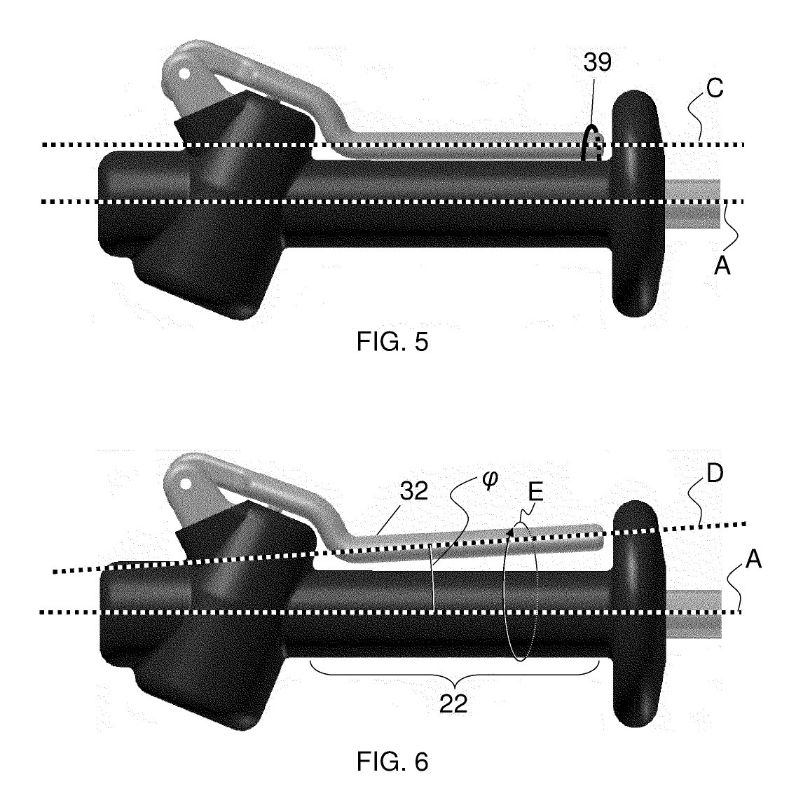

FIGS. 4-6 show views of an airgun body in three different positions. FIG. 4 shows the body with the lever 30 in a first position so that the hand engagement blade is oriented along an axis B that is oblique to axis A by an angle θ. FIG. 5 shows the body with the lever in a second position so that the hand engagement blade is oriented along an axis C that is parallel to axis A. FIG. 6 shows the body with the lever in a third position so that the hand engagement blade is oriented along an axis D that is oblique to axis A by so small an angle φ that the two axes are substantially parallel. The axes are considered “substantially parallel” if the angle φ is not greater than about 10 degrees, not greater than 10 degrees, not greater than about 5 degrees, not greater than five degrees, not greater than about 3 degrees, not greater than three degrees, or small enough to allow a user to contact at least 50%, 60%, 75%, 90%, or 100% of the circumference E around shaft 22 and hand engagement blade 32.

As shown in FIG. 5, a latch 39 or other feature may be provided to hold the lever in the open position. Latch 39 may be transitionable between an engaged position (shown) and a disengaged position (not shown).

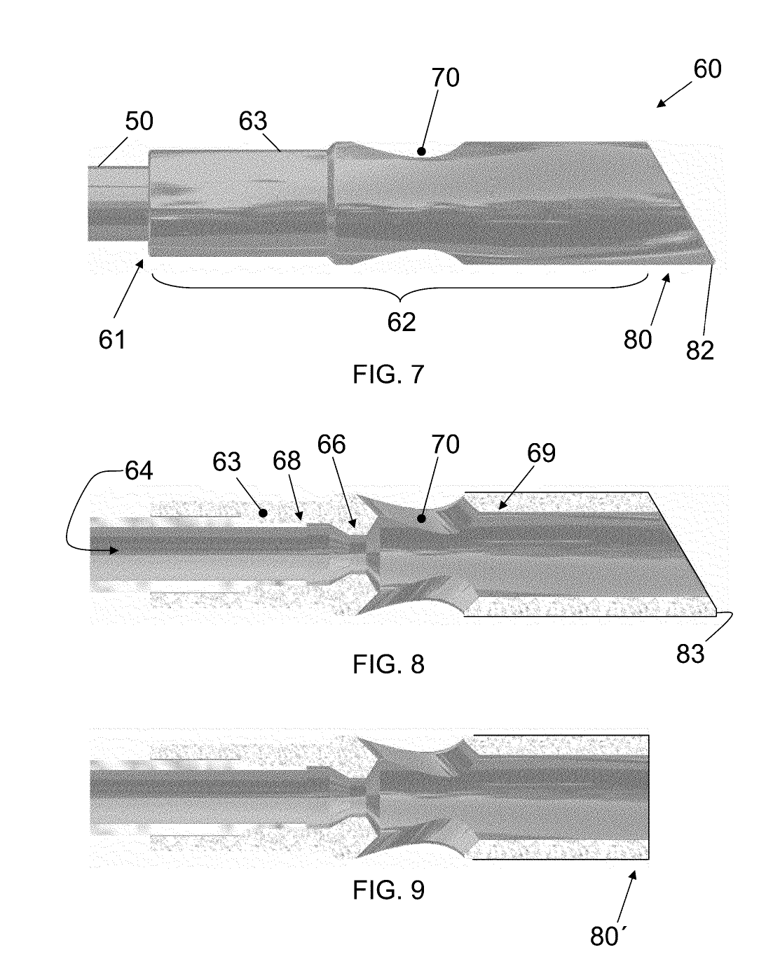

FIGS. 7 and 8 depict side elevation and longitudinal cross-sectional views, respectively, of an exemplary embodiment of a nozzle 60. The nozzle may have a first end 61, second end 80, and a nozzle shaft 62 formed by a wall 63 that defines a nozzle main bore 64. The first end may define an inlet; the second end may define an outlet. The second end may be beveled as shown in FIGS. 7 and 8; alternatively, the second end may be blunt (80′ in FIG. 9).

The beveled end may have a distal tip 82 that may be used as a chisel to strike and/or break up a surface. The distal tip may come to a sharp edge or itself may be slightly blunted (surface 83); a slight blunt increases the surface area available for striking (and consequently decreases the pressure that may be applied to a surface with any given strike), diminishes the risk of jamming the tip in a crevice, and/or helps prevent deforming the tip when striking it against a hard surface.

The nozzle wall may define one or more side holes 70. These side holes may provide an alternate flow route for fluid passing through the nozzle if the outlet is partially or completely obstructed. Such an alternate route can help ensure that the fluid pressure at the nozzle outlet does not exceed some predetermined level.

The main nozzle bore may include a region 66 of reduced diameter between two regions 68, 69 of larger diameter; such a structure, termed as a “venturi,” may cause a pressure drop in fluid at the downstream large-diameter region. In one embodiment, the reduced diameter region has a diameter of about or exactly 0.4375 inches (1.11125 cm). Region 66 may have the smallest diameter in the flow path through the device (when the valve assembly is open); when it does, it meters flow through the device. When line pressure is regulated at 100 psig, the flow rate may be 150 standard cubic feet per minute.

In the depicted embodiment, side holes 70 roughly coincide with large-diameter region 69. Consequently, the pressure drop created in region 69 during operation helps to draw in air through side holes 70 and increase the total amount of flow delivered to the nozzle outlet.

The airguns described herein may be formed from a variety of materials. The materials may be chosen so as to be suited for the expected use. For example, if an airgun will be used primarily for blowing air and not for striking, then the body, extension, and/or nozzle may be made from a lightweight material such as aluminum, titanium, polymers, plastics, polyvinyl chloride, and/or combinations of these. If an airgun is intended for heavier-duty use, such as striking, then the nozzle and/or other parts may be made from a more durable material, such as steel. An airgun may be formed from two or more separate pieces that are attached to one another (e.g. by welding, soldering, brazing, blending, screwing, bolting, and/or press-fitting), and/or one or more parts of the airgun may be formed as a single integral piece.

The airguns described herein may be employed in a number of ways. For example, they may be used to clear debris from a work area (examples include a piece of industrial machinery, forms for receiving concrete or other materials, and areas in which a material has been broken up and the pieces need to be cleared away) or to break up material to be removed (such as concrete or asphalt). While the embodiments described herein concern airguns, those guns may be modified to become, for example, water guns, oil guns, or guns to spray other fluids. The “other” fluid may be supplied to the main bore or other conduit in communication with the main bore so that it may mix with the pressurized air. In this situation, the gun would emit a mixture of air and the “other” fluid. In some embodiments, the pressurized air may be omitted, so that the gun emits a stream of only the “other” fluid.

### EXAMPLES

FIGS. 10 and 11 illustrate exemplary modes of operating the airguns disclosed herein. In FIG. 10, an operator is grasping the body with his hand wrapped around both the shaft and the hand engagement blade. This hand may be oriented so that the operator's fingers touch the hand engagement blade and the palm and/or thumb touches the shaft, or vice versa, or in some intermediate orientation. The operator's other hand grasps the auxiliary handle to help support and direct the airgun. The operator directs the nozzle toward an area from which debris is to be cleared and then depresses the hand engagement blade to open the valve and allow pressurized air to flow through the body, through the nozzle, and out the nozzle outlet. If the operator “dead-ends” the nozzle outlet (i.e., presses it against a surface that occludes the nozzle outlet), sufficient air may escape through the nozzle side holes so that the air pressure provided at the nozzle outlet does not exceed some predetermined level, such as 30 psig. An airgun including this nozzle may thus comply with Occupational Safety and Health Administration Regulation 29 C.F.R. § 1910.242(b), which is interpreted to require that the static pressure at the outlet of a pressurized airgun be less than 30 psig when the outlet is blocked.

FIG. 11 illustrates an operator using the airgun to strike a surface. The operator jabs the nozzle (usually the tip of a beveled nozzle outlet) at the surface, using the buttress on the body and the auxiliary handle to transmit force from his hands and arms to the nozzle.

1. An airgun comprising:
a body including:
a shaft defining a main bore;
a compressed air inlet in fluid communication with a first end of the main bore;
an extension in fluid communication with a second end of the main bore, the extension and the shaft lying along a common axis;
a valve being biased to a closed position and so intersecting the main bore as to regulate flow through the main bore; and
a valve-operating lever attached to the body and operably coupled to the valve, wherein:
the lever includes a hand engagement blade having a free end;
the lever rests in a first position in which the hand engagement blade runs oblique to the common axis of the shaft and the extension and in which the valve adopts the closed position and blocks flow through the main bore; and
the lever is transitionable to a second position in which the hand engagement blade runs parallel or substantially parallel to the common axis of the shaft and the extension and in which the valve adopts an open position and permits flow through the main bore; and
a nozzle attached to and in fluid communication with the extension.

2. The airgun of claim 1, wherein the free end of the hand engagement blade extends toward the extension.

3. The airgun of claim 1, wherein the free end of the hand engagement blade extends toward the inlet.

4. The airgun of claim 1, wherein the inlet lies along the common axis, so that the inlet, the main bore, and the extension are collinear.

5. The airgun of claim 1, wherein the free end of the hand engagement blade extends further from the shaft than any other portion of the body when the lever is in the first position.

6. The airgun of claim 1, wherein at least a portion of the free end of the hand engagement blade lies against at least a portion of the shaft when the lever is in the second position.

7. The airgun of claim 1, wherein at least a portion of the shaft is covered with a thermoset or thermoplastic elastomer.

8. The airgun of claim 1, further comprising a buttress extending from the shaft.

9. The airgun of claim 8, wherein the free end of the hand engagement blade extends toward the extension, and wherein the buttress is positioned on the shaft between the second end of the main bore and a location outside a furthest reach of the free end of the hand engagement blade when the lever is in the second position.

10. The airgun of claim 8, wherein the free end of the hand engagement blade extends toward the inlet, and wherein the buttress is positioned on the shaft between the first end of the main bore and a location outside a furthest reach of the free end of the hand engagement blade when the lever is in the second position.

11. The airgun of claim 1, further comprising a handle attached to the extension.

12. The airgun of claim 1, wherein the nozzle comprises a nozzle shaft defining a main nozzle bore and including:
a wall defining two side holes therethrough;
a first end defining a nozzle inlet and being attached to the extension; and
a beveled second end defining a nozzle outlet.

13. A nozzle for an airgun comprising:
a nozzle shaft defining a main nozzle bore and having:
a wall;
a first end defining an inlet; and
a beveled second end defining an outlet; and
two side holes defined through the shaft wall.

14. The nozzle of claim 13, wherein the nozzle bore defines a region having a diameter that is smaller than that of an upstream region and of a downstream region, and wherein the at least one side hole is positioned in the downstream region.

15. A method of operating the airgun of claim 1 comprising:
directing the nozzle at a site to which pressurized air is to be directed;
grasping the shaft and the hand engagement blade in a hand; and
squeezing the hand engagement blade toward the shaft, thereby opening the valve.

16. The method of claim 15, wherein grasping comprises placing the fingers of the hand on the hand engagement blade and placing the palm and/or thumb of the hand on the shaft.

17. The method of claim 15, wherein grasping comprises placing the finger of the hand on the shaft and placing the palm and/or thumb of the hand on the hand engagement blade.

18. The method of claim 15, further comprising striking the nozzle against the site.

19. The method of claim 18, wherein the nozzle is so beveled as to have a nozzle tip, and striking comprises striking the nozzle tip against the site.

20. The method of claim 18, wherein the airgun further comprises a handle attached to the extension, and the method further comprises grasping the handle with a second hand.
